(19) United States
(12) Patent Application Publication
(10) Pub. No.: US 2014/0023978 A1
(43) Pub. Date: Jan. 23, 2014

(54) DRIVE DEVICE AND THE CORRESPONDING ROTARY KILN

(71) Applicant: FERRY CAPITAIN, Vecqueville (FR)

(72) Inventor: Jean-Baptiste PRUNIER, Joinville (FR)

(73) Assignee: FERRY CAPITAIN, Vecqueville (FR)

(21) Appl. No.: 13/826,002

(22) Filed: Mar. 14, 2013

(30) Foreign Application Priority Data
Jul. 17, 2012 (FR) 12 56912

(51) Int. Cl. F16H 1/04; F27B 7/26

(52) U.S. Cl. CPC F16H 1/04; F27B 7/26
USPC 432/103; 74/412 R

(57) ABSTRACT

This drive device (6) is capable of transmitting a drive torque to the combustion chamber of a rotary kiln. The drive device (6) includes a drive ring gear (8) adapted so as to be attached to the combustion chamber. At least a portion of the drive ring gear (8) is fabricated out of cast iron.

### FIELD OF THE INVENTION

The present invention relates to a drive device for transmitting a drive torque to the combustion chamber of a rotary kiln, the drive device comprising a drive ring gear adapted so as to be attached to the combustion chamber.

### BACKGROUND OF THE INVENTION

From the document WO 2010/67183 a drive device of this type was already known.

Traditionally, drive ring gears for the combustion chamber of a rotary kiln are fabricated out of steel. In the particular case of rotary kilns, no material other than steel has to date been considered given that the stopping of the rotary kiln during heating causes particular difficulties and may lead to failure of the combustion chamber. Steel has thus been deemed resistant enough to provide the necessary reliability. However, steel is expensive and the manufacture of ring gears out of steel is difficult.

### SUMMARY OF THE INVENTION

The invention aims to provide a drive device for a rotary kiln which is economical to manufacture while also offering sufficient reliability.

To this end, the invention relates to a drive device of the type indicated, characterised in that at least a portion of the ring gear is fabricated out of cast iron.

According to particular embodiments, the drive device according to the invention includes one or more of the following characteristic features:
the cast iron is a spheroidal graphite cast iron
the drive ring gear is entirely fabricated out of cast iron.
a drive pinion meshing with the drive ring gear, and preferably comprising a single drive pinion; and
the or each drive pinion is made out of steel.

The invention also relates to a rotary kiln comprising:
a rotary combustion chamber and
a rotary drive device for the combustion chamber, characterised in that the drive device is a device as described above, the drive ring gear being attached so as to be rotatable, to the combustion chamber.

### BRIEF DESCRIPTION OF THE DRAWINGS

The invention will be better understood upon reading the following description provided purely by way of example and with reference made to the accompanying drawings in which:

FIG. 1 is a perspective view of a rotary kiln according to the invention; and

FIG. 2 is a perspective view of the detail II of the rotary kiln according to the invention in FIG. 1.

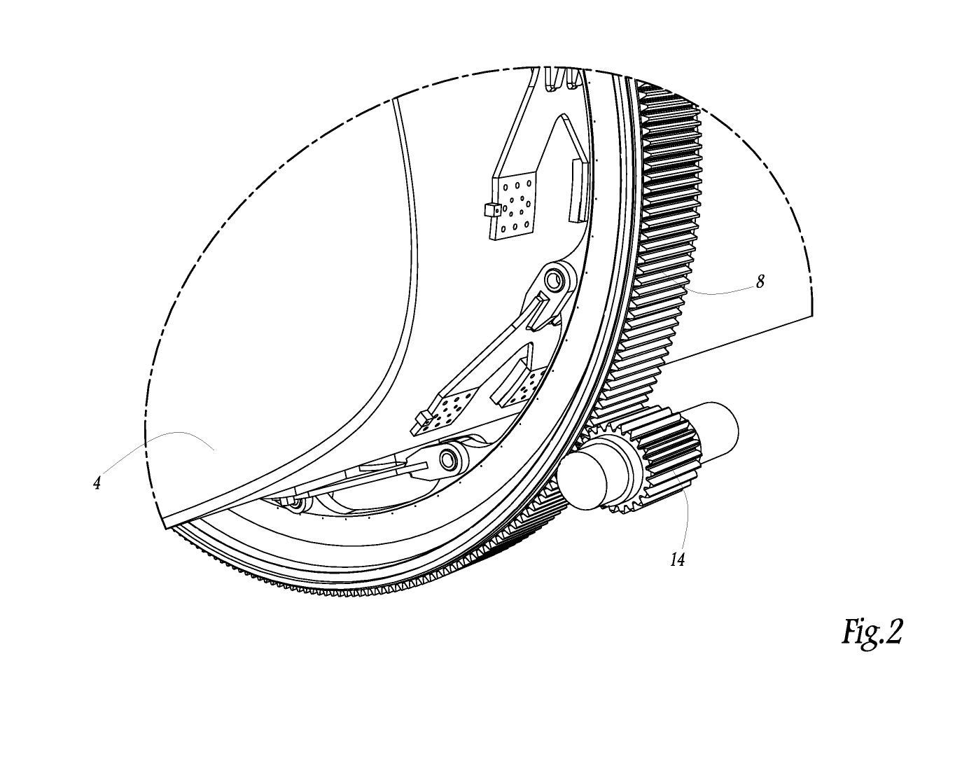

### DETAILED DESCRIPTION OF THE DRAWINGS

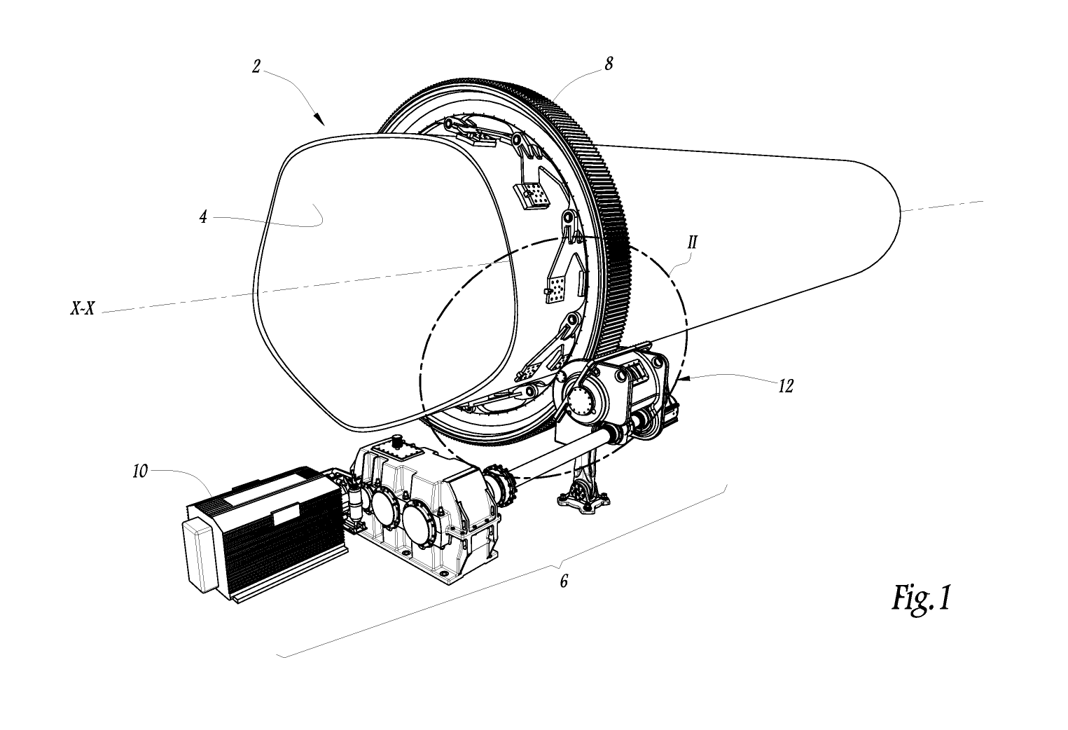

In FIG. 1 is shown a rotary kiln according to the invention, designated by the general reference 2.

The rotary kiln 2 comprises of a combustion chamber 4 and a drive device 6.

The combustion chamber 4 is a generally cylindrical body and is mounted so as to be rotatable about an axis of rotation X-X, for example in bearings not shown.

The drive device 6 is capable of driving the combustion chamber 4 so as to rotate about the axis of rotation X-X.

The drive device 6 comprises of a drive ring gear 8. The ring gear 8 encircles the combustion chamber 4 and is attached so as to be rotatable to the latter.

The drive device 6 also includes a drive motor 10, a gear reducer 12 provided with a drive pinion 14 which is an output pinion for the gear reducer. The drive pinion 14 meshes with the drive ring gear 8. The gear reducer 12 is driven by the drive motor 10. In this case, the drive device comprises a single drive pinion 14.

According to the invention, the ring gear 8 is at least partly fabricated out of cast iron, and preferably from spheroidal graphite cast iron. The ring gear 8 is in particular entirely fabricated out of cast iron, and preferably from spheroidal graphite cast iron.

Moreover, the Brinell hardness (HB) of the cast iron is preferably greater than 250 HB and in particular greater than 320 HB.

Preferably, the or each drive pinion 14 is in particular fabricated out of steel. Preferably the steel of the drive pinion 14 has a Brinell hardness (HB) greater than 320 HB.

The drive device and the rotary kiln according to the invention are economical by reason of their fabrication out of cast iron while also providing in a surprising manner a sufficient degree of reliability for driving the rotary kiln.

1. A drive device (6) for transmitting a drive torque to the combustion chamber of a rotary kiln, the drive device (6) comprising a drive ring gear (8) adapted so as to be attached to the combustion chamber, characterised in that at least a portion of the drive ring gear (8) is fabricated out of cast iron.

2. A drive device according to claim 1, characterised in that the cast iron is a spheroidal graphite cast iron.

3. A drive device according to claim 1, characterised in that the drive ring gear (8) is entirely fabricated out of cast iron.

4. A drive device according to claim 1 comprising a drive pinion (14) meshing with the drive ring gear (8), and preferably comprising a single drive pinion.

5. A drive device according to claim 4, characterised in that the or each drive pinion (14) is made out of steel.

6. A rotary kiln (2) comprising:
a rotary combustion chamber (4) and
a rotary drive device (6) for the combustion chamber 4, characterised in that the drive device (6) is a device according to claim 1, the drive ring gear (8) being attached so as to be rotatable, to the combustion chamber (4).

7. A drive device according to claim 2, characterised in that the drive ring gear (8) is entirely fabricated out of cast iron.

8. A drive device according to claim 2 comprising a drive pinion (14) meshing with the drive ring gear (8), and preferably comprising a single drive pinion.
